(19) United States
(12) Patent Application Publication
(10) Pub. No.: US 2025/0334227 A1
(43) Pub. Date: Oct. 30, 2025

(54) STORAGE TANK

(71) Applicants: Hyundai Motor Company, Seoul (KR); Kia Corporation, Seoul (KR)

(72) Inventor: Chan Jin Kim, Hwaseong-si (KR)

(21) Appl. No.: 18/828,530

(22) Filed: Sep. 9, 2024

(30) Foreign Application Priority Data
Apr. 30, 2024 (KR) 10-2024-0057933

(51) Int. Cl. F17C 1/00

(52) U.S. Cl. CPC F17C 1/00; F17C 2201/0109; F17C 2203/0604; F17C 2203/0607; F17C 2221/012; F17C 2265/01

(57) ABSTRACT

An embodiment storage tank includes a liner configured to define a storage space in the storage tank, wherein the storage space is configured to accommodate a fluid, a composite material surrounding an outer side of the liner, and a catalyst disposed in the composite material, wherein, in a case in which the fluid is hydrogen gas, the catalyst is configured to decompose hydrogen molecules.

### CROSS-REFERENCE TO RELATED APPLICATIONS

This application claims the benefit of Korean Patent Application No. 10-2024-0057933, filed on Apr. 30, 2024, which application is hereby incorporated herein by reference.

### TECHNICAL FIELD

The present disclosure relates to a storage tank.

### BACKGROUND

Hydrogen storage tanks for storing hydrogen gas may be classified into various types of hydrogen storage tanks depending on materials used for the hydrogen storage tanks. Among the hydrogen storage tanks, a TYPE 4 hydrogen storage tank includes a nozzle made of a metallic material, a liner made of a plastic material, and a reinforcement composite material configured to surround the liner. The TYPE 4 hydrogen storage tank is in the limelight because the TYPE 4 hydrogen storage tank may have excellent durability and implement a weight reduction, and the processes of handling and manufacturing the TYPE 4 hydrogen storage tank are relatively simple.

However, in case that the liner made of a plastic material is applied, the hydrogen gas stored in the storage tank often leaks to the outside. In case that the hydrogen gas permeates through the liner, the hydrogen gas, which has permeated through the liner, sometimes cannot be discharged to the outside in a state in which the hydrogen gas is locally collected on an interface between the liner and the composite material. In case that the hydrogen gas is rapidly discharged from the hydrogen storage tank or external vibration is applied to the hydrogen storage tank in this state, there is a problem in that the hydrogen gas, which has permeated through the liner, is discharged along the interface, which may cause a risk of the occurrence of a fire and a buckling phenomenon in which the liner is deformed and separated from the composite material.

### SUMMARY

The present disclosure relates to a storage tank. Particular embodiments relate to a storage tank capable of storing a low-temperature fluid such as hydrogen.

Embodiments of the present disclosure can prevent hydrogen gas, which permeates through a liner of a storage tank, from causing a fire or buckling the liner.

One embodiment of the present disclosure provides a storage tank that has a storage space capable of accommodating a fluid therein, and the storage tank includes a liner configured to define the storage space, a composite material provided to surround an outer side of the liner, and catalysts provided in the composite material or provided at one side of the liner, in which the catalyst is a catalyst capable of decomposing hydrogen molecules.

The catalysts may be dispersed in the composite material.

The storage tank may include an application part applied between the liner and the composite material, in which the catalysts are provided in the application part.

The composite material and the application part may each include epoxy resin.

A first surface of the application part may be provided to face the composite material, and a second surface of the application part, which is opposite to the first surface, may be provided to face the liner.

The storage tank may further include a protection member provided between the application part and the composite material.

The protection member may be provided to be movable relative to the liner.

One surface of the application part may be provided to face the protection member.

The protection member may include a film member or a fiber winding part.

The storage tank may include a cylinder region having a cylindrical shape and dome regions connected to two opposite sides of the cylinder region, in which the catalysts are provided in a region of the storage tank that excludes the dome region.

The storage tank may include a cylinder region having a cylindrical shape and dome regions connected to two opposite sides of the cylinder region, in which the catalysts are provided in the cylinder region and the dome region of the storage tank.

The catalyst may be a metal catalyst.

The catalyst may include at least one of palladium, platinum, platinum alloy, nickel, nickel alloy, and ruthenium.

A particle diameter of the catalyst may be 0.01 micrometers or more and 50 micrometers or less.

A porosity of the composite material may be 8% or lower.

According to embodiments of the present disclosure, it is possible to prevent the hydrogen gas, which permeates through the liner of the storage tank, from causing a fire or buckling the liner.

### BRIEF DESCRIPTION OF THE DRAWINGS

FIG. 1 is a cross-sectional view of a storage tank according to embodiments of the present disclosure.

FIG. 2 is an enlarged view of a cross-sectional structure of a storage tank according to a first embodiment of the present disclosure, i.e., a view illustrating a state before an interior of the storage tank is charged with hydrogen gas.

FIG. 3 is an enlarged view of the cross-sectional structure of the storage tank according to the first embodiment of the present disclosure, i.e., a view illustrating a state immediately after the interior of the storage tank is charged with hydrogen gas.

FIG. 4 is an enlarged view of the cross-sectional structure of the storage tank according to the first embodiment of the present disclosure, i.e., a view illustrating a state in which hydrogen molecules, which permeate through a liner after the interior of the storage tank is charged with hydrogen gas, are decomposed in a composite material.

FIG. 5 is an enlarged view of a cross-sectional structure of a storage tank according to a second embodiment of the present disclosure, i.e., a view illustrating a state before an interior of the storage tank is charged with hydrogen gas.

FIG. 6 is an enlarged view of the cross-sectional structure of the storage tank according to the second embodiment of the present disclosure, i.e., a view illustrating a state immediately after the interior of the storage tank is charged with hydrogen gas.

FIG. 7 is an enlarged view of the cross-sectional structure of the storage tank according to the second embodiment of the present disclosure, i.e., a view illustrating a state in which hydrogen molecules, which permeate through a liner after the interior of the storage tank is charged with hydrogen gas, are decomposed in an application part.

FIG. 8 is an enlarged view of a cross-sectional structure of a storage tank according to a third embodiment of the present disclosure, i.e., a view illustrating a state before an interior of the storage tank is charged with hydrogen gas.

FIG. 9 is an enlarged view of the cross-sectional structure of the storage tank according to the third embodiment of the present disclosure, i.e., a view illustrating a state immediately after the interior of the storage tank is charged with hydrogen gas.

FIG. 10 is an enlarged view of the cross-sectional structure of the storage tank according to the third embodiment of the present disclosure, i.e., a view illustrating a state in which hydrogen molecules, which permeate through a liner after the interior of the storage tank is charged with hydrogen gas, are decomposed in an application part.

### DETAILED DESCRIPTION OF ILLUSTRATIVE EMBODIMENTS

Hereinafter, a storage tank according to embodiments of the present disclosure will be described with reference to the drawings.

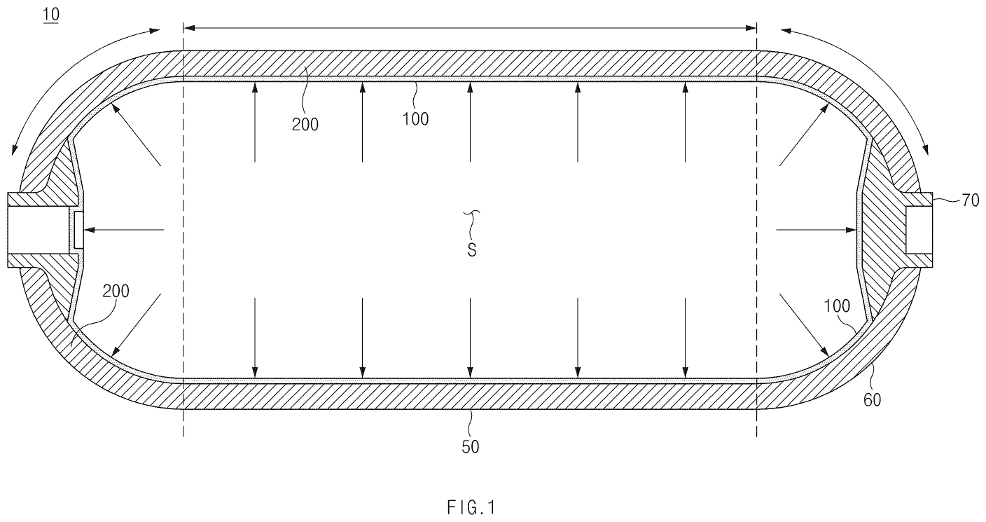

FIG. 1 is a cross-sectional view of a storage tank according to embodiments of the present disclosure.

A storage tank 10 according to embodiments of the present disclosure may have a storage space S capable of accommodating a fluid therein. For example, the storage tank 10 according to embodiments of the present disclosure may be a storage tank for storing hydrogen gas.

With reference to FIG. 1, the storage tank 10 may include a liner 100 configured to define the storage space S and a composite material 200 provided to surround an outer side of the liner 100. For example, the liner 100 may be a liner made of a plastic material. The composite material 200 may have a structure in which a base material, which includes carbon fibers and polymer and is provided in the form of a band, is wound around the outer side of the liner 100.

The storage tank 10 may be divided into a plurality of regions in accordance with a shape of the storage tank 10. That is, with reference to FIG. 1, the storage tank 10 may include a cylinder region 50 having a cylindrical shape, dome regions 60 connected to two opposite longitudinal sides of the cylinder region 50 and each having a dome shape, and a nozzle region 70 inserted into the dome region 60 in the longitudinal direction. More specifically, the liner 100 and the composite material 200 may be provided in the cylinder region 50 and the dome regions 60.

Meanwhile, according to embodiments of the present disclosure, the storage tank 10 may include a catalyst 300 capable of decomposing a molecular structure of the fluid accommodated in the storage space S of the storage tank 10. More specifically, according to embodiments of the present disclosure, the catalyst 300 may be provided in the composite material 200 or provided at one side of the liner 100. As described above, the storage tank 10 according to embodiments of the present disclosure may serve to store hydrogen gas. In this case, the catalyst 300 may be a catalyst capable of decomposing hydrogen molecules.

The catalyst 300 may be configured to decompose gas molecules having permeated through the liner 100 of the storage tank 10. For example, in case that the storage tank 10 stores hydrogen gas, a part of hydrogen in the storage tank 10 permeates through the liner 100 and reaches a region between the liner 100 and the composite material 200. The ‘permeating hydrogen molecules’ may stay in the region between the liner 100 and the composite material 200.

As described above, the catalyst 300 may decompose the permeating hydrogen molecules staying in the region between the liner 100 and the composite material 200, thereby preventing a fire or explosion that occurs when the permeating hydrogen molecules leak along the region between the liner 100 and the composite material 200.

However, the catalyst 300 may be provided in the storage tank 10 so as to decompose only the permeating hydrogen molecules having permeated through the liner 100 as described above. That is, according to embodiments of the present disclosure, the catalyst 300 may be provided at positions at which the catalyst 300 may decompose the hydrogen molecules, which have permeated through the liner 100, without decomposing the hydrogen molecules stored in the storage space S of the storage tank 10. Hereinafter, the catalyst 300 provided in the storage tank 10 according to embodiments of the present disclosure will be described in detail.

The catalyst 300 provided in the storage tank 10 according to embodiments of the present disclosure may be a catalyst that decomposes hydrogen molecules into hydrogen atoms or a catalyst that decomposes hydrogen molecules into hydrogen ions and electrons. For example, the catalyst 300 may be a metal catalyst. For example, the catalyst 300 may include at least one of palladium, platinum, a platinum alloy, nickel, a nickel alloy, and ruthenium. Among these materials, platinum or palladium may not only effectively decompose hydrogen molecules but also may store, in metal, hydrogen ions decomposed from the hydrogen molecules, thereby preventing the buckling of the liner 100 that occurs when the hydrogen gas locally collected is rapidly discharged.

That is, in case that the permeating hydrogen molecules are produced as the pressure in the storage tank 10 is increased when the storage tank 10 is charged with hydrogen gas, the permeating hydrogen molecules may be decomposed into hydrogen ions by the catalyst 300. In this case, because a significant amount of time is required to convert the hydrogen ions into the hydrogen molecules, it is possible to prevent the hydrogen molecules from rapidly leaking to the outside during a subsequent process in which the pressure in the storage tank 10 is decreased and the components of the storage tank 10, such as the liner 100 and the composite material 200, return to original states. Because the effect of storing the hydrogen ions is relatively higher in palladium than in platinum, the most preferable catalyst may be palladium.

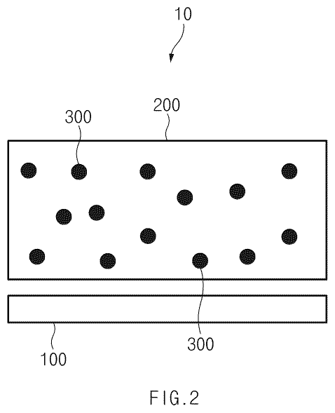

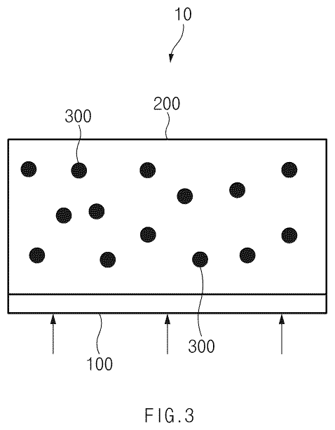

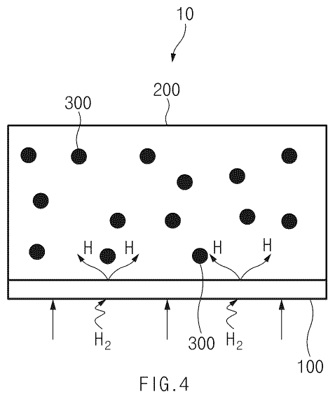

FIG. 2 is an enlarged view of a cross-sectional structure of a storage tank according to a first embodiment of the present disclosure, i.e., a view illustrating a state before an interior of the storage tank is charged with hydrogen gas, and FIG. 3 is an enlarged view of the cross-sectional structure of the storage tank according to the first embodiment of the present disclosure, i.e., a view illustrating a state immediately after the interior of the storage tank is charged with hydrogen gas. FIG. 4 is an enlarged view of the cross-sectional structure of the storage tank according to the first embodiment of the present disclosure, i.e., a view illustrating a state in which hydrogen molecules, which permeate through a liner after the interior of the storage tank is charged with hydrogen gas, are decomposed in a composite material.

With reference to FIGS. 2 to 4, the catalyst 300 provided in the storage tank 10 according to the first embodiment of the present disclosure is dispersed in the composite material 200. That is, according to the first embodiment of the present disclosure, the catalyst 300 may be integrated with the composite material 200. For example, the composite material 200 and the catalyst 300 may be physically mixed and integrally manufactured during a manufacturing process, and then the composite material 200 and the catalyst 300 may be wound around the outer side of the liner 100.

In case that the catalyst 300 is dispersed in the composite material 200 as in the first embodiment of the present disclosure, the hydrogen molecules, which reach the surface or inside of the composite material 200, may be decomposed by the catalyst 300. That is, as illustrated in FIGS. 2 and 3, when the storage tank 10 is charged with the hydrogen gas, an external force is applied to the liner 100 by the pressure of the hydrogen gas, a thickness of the liner 100 decreases, and the liner 100 presses the composite material 200 outward (see FIG. 3), in comparison with the state before the hydrogen gas is stored in the storage tank (see FIG. 2). In this case, as illustrated in FIG. 4, a part of the hydrogen gas in the storage tank 10 permeates through the liner 100 and reaches the region (or interface) between the liner 100 and the composite material 200 or reaches the inside of the composite material 200. In this case, according to embodiments of the present disclosure, because the catalyst 300 is present in the composite material 200, the catalyst 300 decomposes the hydrogen molecules. Therefore, it is possible to prevent the hydrogen molecules from leaking to the outside while flowing along the region between the liner 100 and the composite material 200 or temporally delay a situation in which the hydrogen molecules leak to the outside while flowing along the region between the liner 100 and the composite material 200. Therefore, it is possible to effectively prevent a situation in which the hydrogen molecules are locally concentrated in the region between the liner 100 and the composite material 200 and the liner 100 is buckled.

Furthermore, according to the first embodiment of the present disclosure, because the catalyst 300 is dispersed in the composite material 200, the physical rigidity and strength of the composite material may also be improved in comparison with a composite material only made of a nonmetallic material such as carbon fiber or epoxy. In addition, according to the first embodiment of the present disclosure, in case that the catalyst 300 is a metal catalyst, the heat in the storage tank 10 may be effectively discharged to the outside because of high thermal conductivity of metal. Therefore, even though the temperature of the storage tank 10 is increased by the pressure of the hydrogen gas during the process of charging the storage tank 10 with the hydrogen gas, the thermal energy in the storage tank 10 may be effectively dissipated by the metal catalyst, which may improve the charging speed and the charging amount for charging the storage tank 10 with the hydrogen gas.

Meanwhile, according to the first embodiment of the present disclosure, a porosity of the composite material 200 may be set within a predetermined range in order to effectively delay the time for which the hydrogen ions, which have been decomposed by the catalyst 300, are converted into the hydrogen molecules and the hydrogen molecules are discharged. For example, the porosity of the composite material 200 may be higher than 0% and equal to or lower than 8%.

Meanwhile, the storage tank 10 according to the first embodiment of the present disclosure may be manufactured by i) disposing the liner 100, ii) winding the composite material 200 mixed with the catalyst 300 so that the composite material 200 surrounds the outer side of the liner 100, and iii) curing the composite material 200.

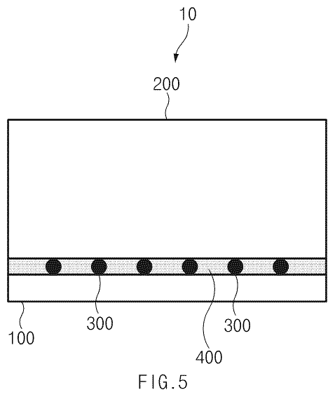

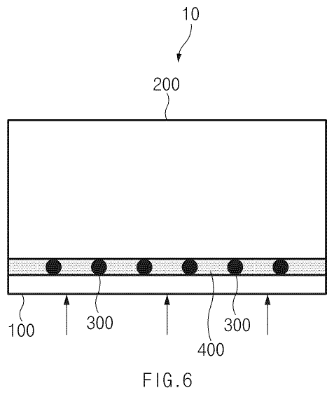

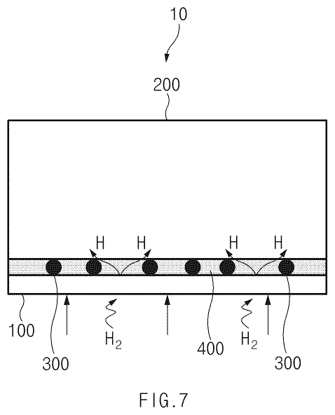

FIG. 5 is an enlarged view of a cross-sectional structure of a storage tank according to a second embodiment of the present disclosure, i.e., a view illustrating a state before an interior of the storage tank is charged with hydrogen gas, and FIG. 6 is an enlarged view of the cross-sectional structure of the storage tank according to the second embodiment of the present disclosure, i.e., a view illustrating a state immediately after the interior of the storage tank is charged with hydrogen gas. FIG. 7 is an enlarged view of the cross-sectional structure of the storage tank according to the second embodiment of the present disclosure, i.e., a view illustrating a state in which hydrogen molecules, which permeate through a liner after the interior of the storage tank is charged with hydrogen gas, are decomposed in an application part.

As in the first embodiment of the present disclosure, the catalyst 300 may be provided in the storage tank 10 according to the second embodiment of the present disclosure. However, the second embodiment of the present disclosure differs from the first embodiment of the present disclosure in that the catalyst 300 is not dispersed in the composite material 200.

That is, with reference to FIGS. 5 to 7, the storage tank 10 according to an embodiment of the present disclosure may further include an application part 400 applied between the liner 100 and the composite material 200. A first surface of the application part 400 may be provided to face the composite material 200, and a second surface of the application part 400, which is opposite to the first surface, may be provided to face the liner 100. For example, the first surface of the application part 400 may be provided to be in direct contact with the composite material 200, and the second surface of the application part 400 may be provided to be in direct contact with the liner 100.

Meanwhile, according to the second embodiment of the present disclosure, the catalyst 300 may be provided in the application part 400. More specifically, the catalyst 300 may be distributed in the application part 400. For example, the application part 400 may be manufactured by physically mixing epoxy resin and the catalyst 300. In this case, according to the second embodiment of the present disclosure, the polymer resin in the composite material 200 and the polymer resin in the application part 400 may be the same material. For example, the composite material 200 and the application part 400 may each include the epoxy resin. In case that the polymer resin in the composite material 200 and the polymer resin in the application part 400 are the same material, it is possible to prevent a problem that may occur because of a difference in physical properties between the composite material 200 and the application part 400. In other embodiments, the composite material 200 and the application part 400 may be made of different materials. For example, the composite material 200 may include the epoxy resin and be configured to maintain a microstructure therein. The application part 400 may include the epoxy resin without maintaining a microstructure therein.

As in the second embodiment of the present disclosure, in case that the catalyst 300 is provided between the liner 100 and the composite material 200 using the application part 400, the hydrogen molecules, which have permeated through the liner 100, may be decomposed by the catalyst 300 before the hydrogen molecules reach the composite material 200. That is, as illustrated in FIGS. 5 and 6, when the storage tank 10 is charged with the hydrogen gas, an external force is applied to the liner 100 by the pressure of the hydrogen gas, a thickness of the liner 100 decreases, and the liner 100 presses the composite material 200 outward (see FIG. 6), in comparison with the state before the hydrogen gas is stored in the storage tank 10 (see FIG. 5). In this case, as illustrated in FIG. 7, a part of the hydrogen gas in the storage tank 10 permeates through the liner 100 and reaches the application part 400. In this case, according to the second embodiment of the present disclosure, because the catalyst 300 is present in the application part 400, the catalyst 300 decomposes the hydrogen molecules. Therefore, it is possible to prevent the hydrogen molecules from leaking to the outside while flowing along the region between the liner 100 and the composite material 200 or temporally delay a situation in which the hydrogen molecules leak to the outside while flowing along the region between the liner 100 and the composite material 200. Therefore, as in the first embodiment of the present disclosure, it is possible to effectively prevent a situation in which the hydrogen molecules are locally concentrated in the region between the liner 100 and the composite material 200 and the liner 100 is buckled.

Meanwhile, the storage tank 10 according to the second embodiment of the present disclosure may be manufactured by i) disposing the liner 100, ii) applying the application part 400, which is mixed with the catalyst 300, onto the outer side of the liner 100, iii) winding the composite material 200 so that the composite material 200 surrounds the outer side of the application part 400, and iv) curing the application part 400 and the composite material 200.

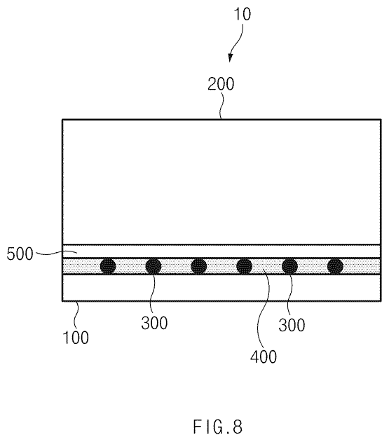

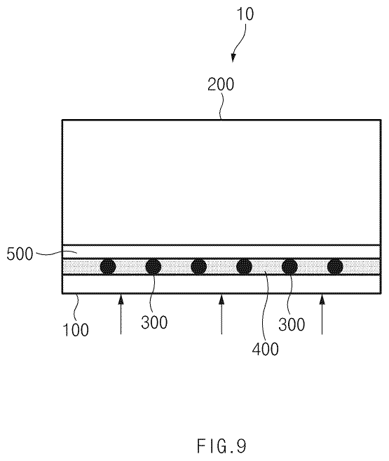

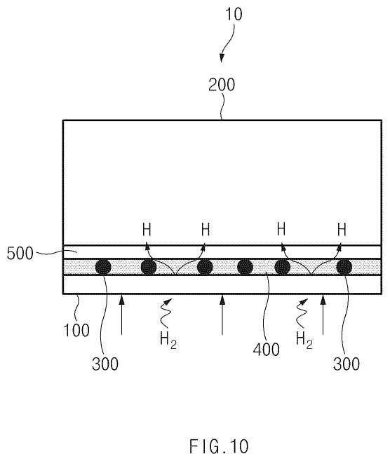

FIG. 8 is an enlarged view of a cross-sectional structure of a storage tank according to a third embodiment of the present disclosure, i.e., a view illustrating a state before an interior of the storage tank is charged with hydrogen gas, and FIG. 9 is an enlarged view of the cross-sectional structure of the storage tank according to the third embodiment of the present disclosure, i.e., a view illustrating a state immediately after the interior of the storage tank is charged with hydrogen gas. FIG. 10 is an enlarged view of the cross-sectional structure of the storage tank according to the third embodiment of the present disclosure, i.e., a view illustrating a state in which hydrogen molecules, which permeate through a liner after the interior of the storage tank is charged with hydrogen gas, are decomposed in an application part.

As in the first and second embodiments of the present disclosure, the catalyst 300 may be provided in the storage tank 10 according to the third embodiment of the present disclosure. However, the third embodiment of the present disclosure differs from the first and second embodiments of the present disclosure in that a protection member 500 may be additionally provided in the storage tank 10 in addition to the catalyst 300.

That is, with reference to FIGS. 8 to 10, according to the third embodiment of the present disclosure, the storage tank 10 may further include the protection member 500 provided between the application part 400 and the composite material 200.

For example, with reference to FIGS. 8 to 10, the protection member 500 may be joined to the composite material 200 and provided to be movable relative to the liner 100. For example, a curing process may be performed during the process of manufacturing the storage tank 10. The protection member 500 and the composite material 200 may be joined to each other during the curing process. However, unlike the above-mentioned configuration, the protection member 500 may be provided to be movable relative to the liner 100 without being joined to the composite material 200.

In this case, according to the third embodiment of the present disclosure, the application part 400 including the catalyst 300 may be provided between the liner 100 and the composite material 200. More specifically, one surface of the application part 400 may be provided to face the protection member 500. That is, the protection member 500 may be provided to face the application part 400 and the composite material 200.

The application part 400 according to the third embodiment of the present disclosure may be configured to prevent the composite material 200 from being scratched when the storage tank 10 is deformed by the pressure. That is, the internal pressure of the storage tank 10 is changed during the process in which the storage tank 10 is charged with the hydrogen gas and the hydrogen gas is discharged from the storage tank 10. The components, such as the liner 100 and the application part 400, are repeatedly deformed in shape while the pressure in the storage tank 10 is changed.

In this case, according to the third embodiment of the present disclosure, the protection member 500 may be configured to prevent a surface of the composite material 200 from being scratched by a force applied to the surface of the composite material 200 while the application part 400 is deformed in shape. That is, according to the third embodiment of the present disclosure, the force, which is applied when the application part 400 is deformed in shape, is applied to the application part 400 instead of the composite material 200, such that the composite material 200 may be effectively protected.

Meanwhile, the protection member 500 may be a film member having a sheet shape. However, the protection member 500 may be a winding member provided in the form of a band wound around the outer side of the liner 100 and the outer side of the application part 400. For example, the protection member 500 may be a fiber winding part.

Meanwhile, the storage tank 10 according to the third embodiment of the present disclosure may be manufactured by i) disposing the liner 100, ii) applying the application part 400, which is mixed with the catalyst 300, onto the outer side of the liner 100, iv) disposing the protection member 500 on the outer side of the application part 400, v) winding the composite material 200 so that the composite material 200 surrounds the outer side of the protection member, and vi) curing the application part 400, the protection member 500, and the composite material 200.

Meanwhile, according to the first to third embodiments of the present disclosure, the catalyst 300 may be provided at least in the cylinder region 50 of the storage tank 10. This is because the permeating hydrogen molecules may be concentrated relatively in the cylinder region 50 rather than the dome regions 60. That is, the components, such as the liner 100, which are deformed by the pressure of the hydrogen gas in the storage tank 10, are relatively more greatly deformed in the cylinder region 50 than in the dome regions 60, and the liner 100 is buckled greatly in the cylinder region 50 by the deformation. Therefore, the catalyst 300 according to embodiments of the present disclosure may be provided at least in the cylinder region 50.

For example, the catalyst 300 may be provided in a region of the storage tank 10 that excludes the dome regions 60 and the nozzle region 70. However, the present disclosure is not limited thereto. The catalyst 300 may be provided in both the cylinder region 50 and the dome regions 60. The catalyst 300 may be provided even in the nozzle region 70.

Meanwhile, sizes of particles, which constitute the catalyst 300 provided in the storage tank 10 according to embodiments of the present disclosure, may be restricted to a predetermined range. That is, according to embodiments of the present disclosure, a particle diameter of the catalyst 300 may be 0.01 micrometers or more and 50 micrometers or less in order to prevent the catalyst 300 from separating from the storage tank 10 during the processes of charging the storage tank 10 with the hydrogen gas and discharging the hydrogen gas from the storage tank 10 and to allow the catalyst 300 to improve the physical rigidity and strength of the composite material 200.

The present disclosure has been described with reference to the exemplary embodiments and the drawings, but the present disclosure is not limited thereby. The present disclosure may be carried out in various forms by those skilled in the art, to which the present disclosure pertains, within the technical spirit of the present disclosure and the scope equivalent to the appended claims.

What is claimed is:

1. A storage tank comprising:
a liner configured to define a storage space in the storage tank, wherein the storage space is configured to accommodate a fluid;
a composite material surrounding an outer side of the liner; and
a catalyst disposed in the composite material, wherein, in a case in which the fluid is hydrogen gas, the catalyst is configured to decompose hydrogen molecules.

2. The storage tank of claim 1, wherein the catalyst is dispersed in the composite material.

3. The storage tank of claim 1, further comprising:
a cylinder region having a cylindrical shape; and
dome regions connected to two opposite sides of the cylinder region, wherein the catalyst is disposed on the cylinder region and is not disposed in the dome regions.

4. The storage tank of claim 1, further comprising:
a cylinder region having a cylindrical shape; and
dome regions connected to two opposite sides of the cylinder region, wherein the catalyst is disposed in the cylinder region and the dome regions.

5. The storage tank of claim 1, wherein the catalyst comprises a metal catalyst.

6. The storage tank of claim 1, wherein the catalyst comprises palladium, platinum, platinum alloy, nickel, nickel alloy, or ruthenium.

7. The storage tank of claim 1, wherein a particle diameter of the catalyst is 0.01 micrometers or more and 50 micrometers or less.

8. The storage tank of claim 1, wherein a porosity of the composite material is 8% or lower.

9. A storage tank comprising:
a liner configured to define a storage space in the storage tank, wherein the storage space is configured to accommodate a fluid;
a composite material surrounding an outer side of the liner; and
a catalyst disposed at the outer side of the liner facing the composite material, wherein, in a case in which the fluid is hydrogen gas, the catalyst is configured to decompose hydrogen molecules.

10. The storage tank of claim 9, further comprising an application part disposed between the liner and the composite material, wherein the catalyst is disposed in the application part.

11. The storage tank of claim 10, wherein the composite material and the application part each comprise an epoxy resin.

12. The storage tank of claim 10, wherein a first surface of the application part faces the composite material and a second surface of the application part, opposite the first surface, faces the liner.

13. The storage tank of claim 10, further comprising a protection member disposed between the application part and the composite material.

14. The storage tank of claim 13, wherein the protection member is movable relative to the liner.

15. The storage tank of claim 13, wherein a first surface of the application part faces the protection member.

16. The storage tank of claim 13, wherein the protection member comprises a film member or a fiber winding part.

17. The storage tank of claim 9, wherein the catalyst comprises a metal catalyst.

18. The storage tank of claim 9, wherein the catalyst comprises palladium, platinum, platinum alloy, nickel, nickel alloy, or ruthenium.

19. The storage tank of claim 9, wherein a particle diameter of the catalyst is 0.01 micrometers or more and 50 micrometers or less.

20. The storage tank of claim 9, wherein a porosity of the composite material is 8% or lower.
